(19) United States
(12) Patent Application Publication
(10) Pub. No.: US 2025/0018815 A1
(43) Pub. Date: Jan. 16, 2025

(54) PRE-CHARGING OF LOAD

(71) Applicant: VOLVO TRUCK CORPORATION, Göteborg (SE)

(72) Inventors: Emil LIDSTRÖM, Torslanda (SE); David TUTUSAUS MARTINEZ, Vänersborg (SE)

(73) Assignee: VOLVO TRUCK CORPORATION, Göteborg (SE)

(21) Appl. No.: 18/768,763

(22) Filed: Jul. 10, 2024

(30) Foreign Application Priority Data
Jul. 12, 2023 (EP) 23185043.9

(51) Int. Cl. B60L 53/62; B60L 3/00

(52) U.S. Cl. CPC B60L 53/62; B60L 3/0046; B60L 2240/547; B60L 2240/549

(57) ABSTRACT

A computer system is presented. The computer system comprises processing circuitry configured to control a first battery pack and a second battery pack to provide pre-charge to a load. The processing circuitry is further configured to configure the first battery pack to provide pre-charge in a supporting pre-charge mode, and during pre-charge in the supporting pre-charge mode, monitor a first voltage difference indicator indicating a difference between a load voltage and a first battery pack voltage. The processing circuitry is further configured to, responsive to the first voltage difference indicator indicating that first battery pack voltage is at or below the load voltage, control the first battery pack to discontinue pre-charge of the load.

### TECHNICAL FIELD

The disclosure relates generally to power management. In particular aspects, the disclosure relates to pre-charging of a load. The disclosure can be applied marine vessels, industrial applications and vehicles, specifically heavy-duty vehicles, such as trucks, buses, and construction equipment, among other vehicle types. Although the disclosure may be described with respect to a particular vehicle, the disclosure is not restricted to any particular vehicle.

### BACKGROUND

Pre-charging is a technique used to limit an inrush current that occurs when energizing a load. This is specifically the case for inductive loads such as a motor or transformer. Inductive loads are characterized by their ability to store energy in their magnetic field, and when power is initially applied, this stored energy may cause a surge of current to flow. Similarly, largely capacitive loads exhibit, for an initial time period when powered, almost zero resistance. A voltage traction bus of a vehicle is both inductive and capacitive. Pre-charging involves gradually applying voltage to the load, allowing it to build up the magnetic field and reduce the inrush current.

The purpose of pre-charging is to protect the electrical system from the excessive currents that may occur during the energization of loads. High inrush currents may cause voltage sags, trip circuit breakers, damage components, and/or disrupt the normal operation of other devices connected to the same power source. To exemplify, if a voltage drop over e.g. contactors between a battery and a load is too high, there may be an arch through the small air gap before the contactor is completely closed due to the inrush current. This may damage or even weld the contactor.

However, there are some potential problems associated with pre-charging loads. Pre-charging generally requires additional circuitry and control mechanisms to gradually apply the voltage to the load. This may increase the complexity of the system design and add extra components, leading to higher costs and maintenance requirements. It also takes time to complete the pre-charging process, which may not be suitable for applications where quick energization is required. During the pre-charging process, voltage is applied gradually, which means the load receives an increasing voltage until the pre-charging is complete. This may result in a voltage drop, potentially affecting the operation of other devices connected to the same power source. The reliability of the control system responsible for pre-charging is important. If the control system malfunctions or fails, it may cause improper pre-charging, resulting in higher inrush currents and potential damage to the load or the electrical system.

### SUMMARY

According to a first aspect of the disclosure, a computer system is presented. The computer system comprises processing circuitry configured to control a first battery pack and a second battery pack to provide pre-charge to a load, and to configure the first battery pack to provide pre-charge in a supporting pre-charge mode. The processing circuitry is further configured to, during pre-charge in the supporting pre-charge mode, monitor a first voltage difference indicator indicating a difference between a load voltage and a first battery pack voltage, and responsive to the first voltage difference indicator indicating that first battery pack voltage is at or below the load voltage, control the first battery pack to discontinue pre-charge of the load. The first aspect of the disclosure may seek to reduce potential drawback with uneven voltages of batteries joining to pre-charge a load. A technical benefit may include reducing a time it takes to pre-charge a load.

Optionally in some examples, including in at least one preferred example, the processing circuitry is further configured to monitor a pre-charge current between the first battery pack and the load, and determine the first voltage difference indicator based on the pre-charge current. A technical benefit may include obtaining a readily available indication of if the battery pack is contributing to the pre-charging of the load or not.

Optionally in some examples, including in at least one preferred example, the processing circuitry is further configured to monitor the first battery pack voltage and the load voltage, and determine the first voltage difference indicator based on the first battery pack voltage and the load voltage. A technical benefit may include obtaining a readily available indication of if the battery pack is contributing to the pre-charging of the load or not.

Optionally in some examples, including in at least one preferred example, the processing circuitry is further configured to, during pre-charge in the supporting pre-charge mode, monitor a second voltage difference indicator indicating a difference between the load voltage and a second battery pack voltage, and responsive to the second voltage difference indicator indicating that the second battery pack voltage is at or below the load voltage, control the first battery pack to discontinue pre-charge of the load. A technical benefit may include being able to respond also if the battery pack operating in the supporting pre-charge mode is charging other battery packs partaking in the pre-charge of the load.

Optionally in some examples, including in at least one preferred example, the processing circuitry is further configured to obtain at least one of an open cell voltage or a loaded cell voltages of each battery pack of a battery system comprising more than two battery packs, and select the first battery pack and the second battery pack by selecting a pair of battery packs of the two or more battery packs of the battery system having the lowest difference in open cell voltages and/or loaded cell voltages of each pair of battery packs of the two or more battery packs of the battery system. A technical benefit may include reducing a risk that the batteries used for pre-charging, at least initially, have different voltages.

Optionally in some examples, including in at least one preferred example, the processing circuitry is further configured to monitor a pre-charge current between the first battery pack and the load, and determine the first voltage difference indicator based on the pre-charge current; monitor the first battery pack voltage and the load voltage, and determine the first voltage difference indicator based on the first battery pack voltage and the load voltage; during pre-charge in the supporting pre-charge mode, monitor a second voltage difference indicator indicating a difference between the load voltage and a second battery pack voltage, and responsive to the second voltage difference indicator indicating that the second battery pack voltage is at or below the load voltage, control the first battery pack to discontinue pre-charge of the load; and obtain at least one of an open cell voltage or a loaded cell voltages of each battery pack of a battery system comprising more than two battery packs, and select the first battery pack and the second battery pack by selecting a pair of battery packs of the two or more battery packs of the battery system having the lowest difference in open cell voltages and/or loaded cell voltages of each pair of battery packs of the two or more battery packs of the battery system.

In a second aspect of the present disclosure, a computer implemented method is presented. The method comprises, controlling, by processing circuitry of a computer system, a first battery pack and a second battery pack to provide pre-charge to a load, and configuring, by the processing circuitry of the computer system, the first battery pack to provide pre-charge in a supporting pre-charge mode. The method further comprises, during pre-charge in the supporting pre-charge mode, monitoring, by the processing circuitry of the computer system, a first voltage difference indicator indicating a difference between a load voltage and a first battery pack voltage, and responsive to the first voltage difference indicator indicating that first battery pack voltage is at or below the load voltage, controlling, by the processing circuitry of the computer system, the first battery pack to discontinue pre-charge of the load. The second aspect of the disclosure may seek to reduce potential drawback with uneven voltages of batteries joining to pre-charge a load. A technical benefit may include reducing a time it take to pre-charge a load.

Optionally in some examples, including in at least one preferred example, the computer implemented method further comprises monitoring, by the processing circuitry of the computer system, a pre-charge current between the first battery pack and the load, and determining, by the processing circuitry of the computer system, the first voltage difference indicator based on the pre-charge current. A technical benefit may include obtaining a readily available indication of if the battery pack is contributing to the pre-charging of the load or not.

Optionally in some examples, including in at least one preferred example, the computer implemented method further comprises monitoring, by the processing circuitry of the computer system, the first battery pack voltage and the load voltage, and determining, by the processing circuitry of the computer system, the first voltage difference indicator based on the first battery pack voltage and the load voltage. A technical benefit may include obtaining a readily available indication of if the battery pack is contributing to the pre-charging of the load or not.

Optionally in some examples, including in at least one preferred example, the computer implemented method further comprises, during pre-charge in the supporting pre-charge mode, monitoring, by the processing circuitry of the computer system, a second voltage difference indicator indicating a difference between the load voltage and a second battery pack voltage, and responsive to the second voltage difference indicator indicating that the second battery pack voltage is at or below the load voltage, controlling, by the processing circuitry of the computer system, the first battery pack to discontinue pre-charge of the load. A technical benefit may include being able to respond also if the battery pack operating in the supporting pre-charge mode is charging other battery packs partaking in the pre-charge of the load.

Optionally in some examples, including in at least one preferred example, the computer implemented method further comprises, obtaining, by the processing circuitry of the computer system, at least one of an open cell voltage or a loaded cell voltages of each battery pack of a battery system comprising more than two battery packs, and selecting, by the processing circuitry of the computer system, the first battery pack and the second battery pack by selecting a pair of battery packs of the two or more battery packs of the battery system having the lowest difference in open cell voltages and/or loaded cell voltages of each pair of battery packs of the two or more battery packs of the battery system. A technical benefit may include reducing a risk that the batteries used for pre-charging, at least initially, have different voltages.

In a third aspect of the present disclosure, a vehicle is presented. The vehicle comprises a first battery pack, a second battery pack and the computer system of any one of the first aspect operatively connected to the first battery pack and the second battery pack.

Optionally in some examples, including in at least one preferred example, the vehicle is a heavy-duty vehicle.

In a fourth aspect of the present disclosure, a computer program product is presented. The computer program product comprises program code for performing, when executed by a processing circuitry of a computer system, the computer implemented method of the second aspect.

In a fifth aspect of the present disclosure, a non-transitory computer-readable storage medium is presented. The non-transitory computer-readable storage comprises instructions, which when executed by a processing circuitry of a computer system, cause the processing circuitry to perform the computer implemented method of the second aspect.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to 30 those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1A is a side view of an exemplary vehicle according to an example.

FIG. 1B is a schematic view of an exemplary vehicle according to an example.

FIG. 2 is a schematic view of an exemplary battery pack operatively connected to a computer system according to an example.

FIG. 3 is a schematic view of an exemplary battery pack operatively connected to a computer system according to an example.

FIG. 4 is a schematic view of a pre-charge controller according to an example.

FIG. 5 is a schematic view of a pre-charge controller according to an example.

FIG. 6 is a block diagram of a battery system according to an example.

FIG. 7 is a schematic view method for providing pre-charge to a load according to an example.

FIG. 8 is a schematic view of a computer program product according to an example.

FIG. 9 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

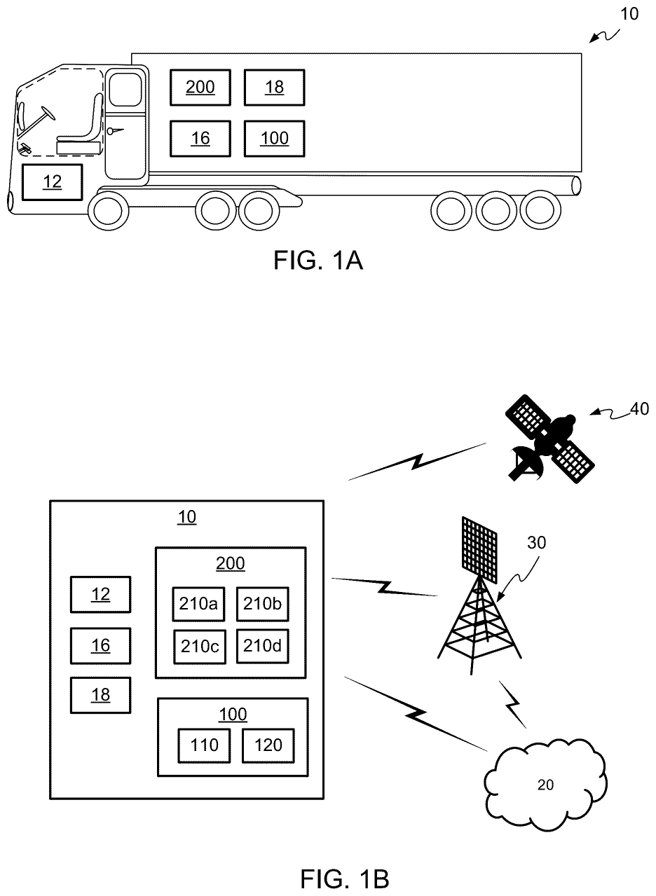

FIG. 1A is an exemplary schematic side view of a heavy-duty vehicle 10 (hereinafter referred to vehicle 10 for reasons of brevity). This particular vehicle 10 comprises a tractor unit 10a which is arranged to tow a trailer unit 10b. In other examples, other heavy-duty vehicles may be employed, e.g., trucks, buses, and construction equipment. Although not explicitly visualized in FIG. 1A, the skilled person will appreciate that the vehicle 10 comprises all necessary vehicle units and associated functionality such that it may operate as the skilled person would expect of a vehicle 10, such as a powertrain, chassis, and various control systems. Emphasis in the present disclosure is rather directed at pre-charge control of the vehicle 10, and therefore functionality and features related this will be the focus of the present disclosure. However, the vehicle 10 comprises one or more propulsion sources 12. The propulsion source 12 may be any suitable propulsion source 12 exemplified by, but not limited to, one or more or a combination of an electrical motor, a combustion engine such as a diesel, gas or gasoline powered engine. The vehicle 10 further comprises an energy source 200 suitable for providing energy for the propulsion source 12. That is to say, if the propulsion source 12 is an electrical motor, a suitable energy source 200 would be a battery or a fuel cell. The vehicle 10 further comprises sensor circuitry 16 arranged to detect, measure, sense or otherwise obtain data relevant for operation of the vehicle 10. The data relevant for operation of the vehicle 10 may be exemplified by, but not limited to, one or more of a speed of the vehicle 10, a weight of the vehicle 10, an inclination of the vehicle 10, a status (state of charge, fuel level etc.) of the energy source 200 of the vehicle 10, a presence of road users in a vicinity of the vehicle 10, a current speed limit of a current road travelled by the vehicle 10 etc. Advantageously, the vehicle 10 further comprises communications circuitry 18 configured for communication with, to the vehicle 10, external devices. The vehicle 10 further comprises a computer system 100, the computer system 100 will be further explained in following sections.

Advantageously, a vehicle 10 according to the present disclosure is an, at least partly, electrically propelled vehicle. To this end, the vehicle 10 of the present disclosure comprise at least one energy source 200 is the form of an electrical energy source. In FIG. 1B, a block diagram of the vehicle 10 is shown. The vehicle energy source 200 comprises at least two battery packs 210a, 210b, 210c, 210d. In FIG. 1B, the vehicle energy source 200 is shown comprising four battery packs 210a, 210b, 210c, 210d. However, this is for illustrative purposes, and the energy source 200 may comprise any number of battery packs 210a, 210b, 210c, 210d. The battery packs 210a, 210b, 210c, 210d may be connected in series, in parallel or a combination of series or parallel connections in order to provide a rated voltage an capacity from the energy source 200. For the present disclosure, it is assumed that the at least two battery packs 210a, 210b, 210c, 210d are connected in parallel. In some examples, a voltage of the energy source is approximately 800 V.

The vehicle 10 may communicate with a cloud server 20 directly, via the communications circuitry 18, or via a communications interface, via the communications circuitry 18, such as a cellular communications interface exemplified by a radio base station 30 in FIG. 1B. The cloud server 20 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface is advantageously a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. The vehicle 10 may further be operatively connected to a Global Navigation Satellite System (GNSS) 40, via the communications circuitry 18, exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 10 may be configured to utilize data obtain from the GNSS 40 to determine a geographical location of the vehicle 10.

The computer system 100 of the vehicle 10 is advantageously operatively connected to the communications circuitry 18, the sensor circuitry 16, the energy source 200 and/or the propulsion source 12 of the vehicle 10. The computer system 100 comprises processing circuitry 110. The computer system 100 may comprise a storage device 120, advantageously a non-volatile storage device such as hard disk drives (HDDs), solid-state drives (SSDs) etc. In some examples, the storage device 120 is operatively connected to the computer system 100.

The energy source 200 is advantageously configured to provide energy to, at least, the propulsion source 12 of the vehicle 10. Additionally, or alternatively, the energy source 200 may be configured to provide energy to other parts or components of the vehicle 10 such as, but not limited to, vehicle electronics, climate control of the vehicle 10, safety functions of the vehicle etc. Regardless of the load, it may be advantageous to control the connection of the energy source 200 to the load in order to reduce inrush current flowing from the energy source 200 into the load. In the context of electrical vehicles, pre-charging may be interpreted as slowly increasing a voltage of a traction voltage bus of the vehicle 10. It should be mentioned that the traction voltage bus of a vehicle 10 generally presents an, at least partly, capacitive load that may cause high inrush currents if proper pre-charge of the traction voltage bus is omitted. The voltage of the traction voltage bus is slowly increased until it reaches a threshold voltage. Generally, the threshold voltage correspond to, or is similar to, a voltage of the energy source 200. When the voltage of the traction bus reaches the voltage threshold, pre-charging is completed and normal operation of the vehicle may commence.

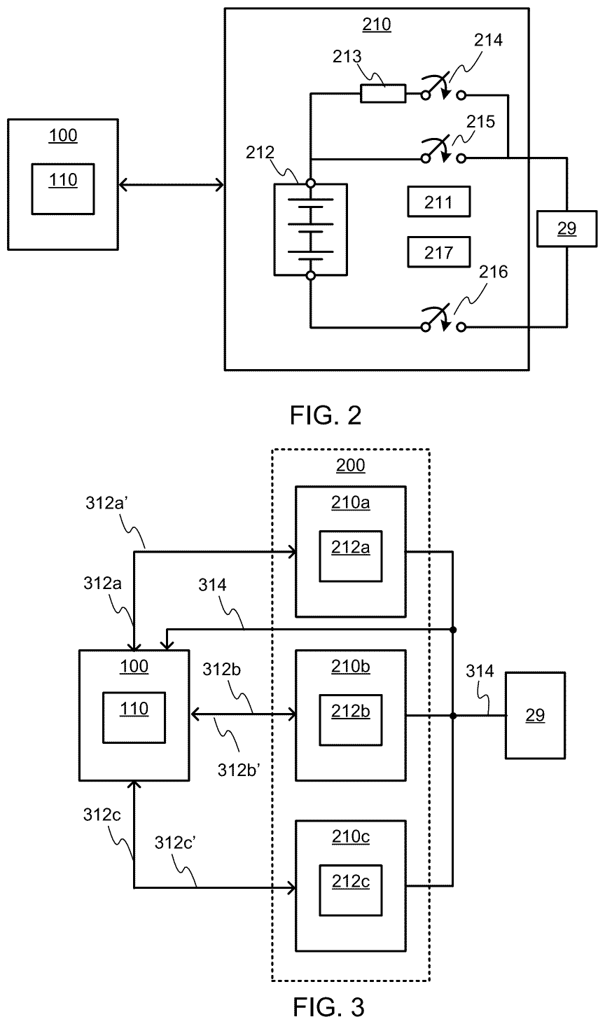

In FIG. 2, a schematic view of a battery pack 210 connected to a generic load 29 and the computer system 100 is shown. The load 29 advantageously comprises the traction voltage bus of the vehicle 10. The battery pack 210 comprises one or more battery cells 212 connected in series and/or in parallel in order to provide a configured voltage and capacitance of the battery pack 210. The battery back 210 advantageously comprises first switch circuitry 215 arranged to connect a first pole of the one or more battery cells 212 to the load 29. The battery pack 210 advantageously comprises a pre-charge load 213 operatively connected between the one or more battery cells 212 and the load 29. The pre-charge load 213 is configured to limit a current from the one or more battery cells 212 during pre-charge. The pre-charge load 213 may be any suitable circuitry configured to limit the current from the one or more battery cells 213 such a resistor. The battery back 210 advantageously comprises second switch circuitry 214 arranged to selectively close an electric circuit between the one or more battery cells 212, the pre-charge load 213 and the load 29. The battery back 210 advantageously comprises third switch circuitry 216 arranged to connect a second pole of the one or more battery cells 212 to the load 29.

The battery back 210 advantageously comprises a battery pack processing circuitry 211. The battery pack processing circuitry 211 may be configured to control operation of the battery pack 210. The battery pack 210 may further comprise one or more sensor circuitry 217 configured to detect, measure, sense or otherwise obtain, operational data relating to the battery pack 210. Operational data relating to the battery pack 210 may be exemplified by, but should not be considered limited to, a voltage of one or more of the battery cells 212, a status of the switch circuitries 214, 215, 216, a voltage of the load 29, a current through the pre-charge load 213, a current from the battery cells 212 (and thereby a current to the battery cells 212 in case of e.g. charging) etc.

Generally, during pre-charge, the processing circuitry 110 of the computer system 100 may instruct the battery pack processing circuitry 211 to close the second switch circuitry 214 and, if present, the third switch circuitry 216. This will cause the battery back 210 to pre-charge the load 29. The processing circuitry 110 of the computer system 100 generally monitors a voltage of the load 29 and, as the voltage of the load 29 reaches the threshold, the processing circuitry 110 of the computer system 100 may instruct the battery pack processing circuitry 211 to open the second switch circuitry 214 and close the first switch circuitry 215, whereby the battery pack 210 is operational to provide a rated current to the load 29. In some examples, it may be advantageous to close the first switch circuitry 215 prior to opening the second switch circuitry 214 in order to keep a voltage across the load 29 stable until the mechanical movement (arcing potential) of the first switch 215 is completed.

Pre-charging as described above is comparably slow. It may take more than 1 s to pre-charge a load 29 from a single battery pack 210. Further to this, if only one battery back 210 is utilized, the pre-charge load 213 of that battery back 210 will have to be dimensioned to handle sufficiently high currents and/or energy in order to keep pre-charge time low. This will result in a costly and physically large pre-charge load. It may be possible to address these shortcomings by connecting more than one battery pack 210 to the load 29 during pre-charge. This will potentially double the pre-charge current, or allow a current handling and/or energy handling of the pre-charge loads 213 to be reduced thereby reducing a cost and size of the pre-charge load 213 (and effectively the battery pack 210).

However, the inventor behind the present disclosure have, through inventive thinking and challenging of technical prejudices related to pre-charge, realized that there is further room for improvement. Pre-charge with more than one battery pack may function sufficiently if a voltage of both battery packs is the same. If one battery pack has a voltage that is lower than another battery pack, the battery pack having the higher voltage will, when a voltage of the load 29 reaches or exceeds the voltage of the battery pack having the lower voltage, charge the battery pack having the lower voltage. This is undesirable as this may actually prolong the pre-charge or completely inhibit the completion of the pre-charge. The inventor have realized that it may very well be, that although two battery packs exhibit similar voltages when unloaded, their respective voltages may very well change differently when they are loaded. However, also unloaded voltage differences between two battery packs are common and may be caused by e.g. replacement of one battery pack, self-discharge, mechanical and/or chemical faults, certain charging functions leading to unbalanced packs etc. To this end, it is beneficial to monitor a voltage difference between each of the battery packs and a load voltage during pre-charge. If the voltage of a battery pack is below, or at, the voltage of the load 29, pre-charging by that battery pack is advantageously discontinued.

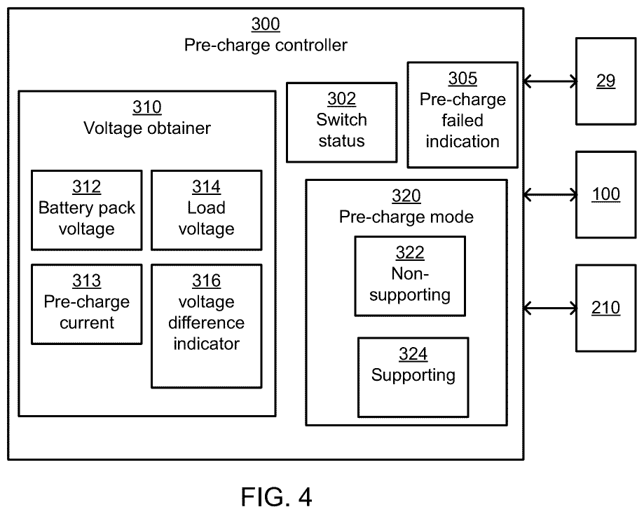

In FIG. 3 an exemplary view of a computer system 100 is shown. In FIG. 3, the computer system 100 is connected to a first battery pack 210a, a second battery pack 210b, a third battery pack 210c and a load 29. The processing circuitry 110 of the computer system 100 is configured to control, or cause control, of pre-charge of each of the battery packs 210a, 210b, 210c. The processing circuitry 110 may be configured to obtain a load voltage 314 indicating a voltage of the load 29. The processing circuitry 110 may be configured to obtain a first battery pack voltage 312a indicating a voltage of the one or more battery cells 212a of the first battery pack 210a. Advantageously, the first battery pack voltage 312a indicates a loaded voltage of the one or more battery cells 212a of the first battery pack 210a. Additionally, or alternatively, the processing circuitry 110 may be configured to obtain a further first battery pack voltage 312a′ indicating an open cell voltage, i.e. an unloaded voltage, of the one or more battery cells 212a of the first battery pack 210a. The processing circuitry 110 may be configured to obtain a second battery pack voltage 312b indicating a voltage of the one or more battery cells 212b of the second battery pack 210a. Advantageously, the second battery pack voltage 312b indicates a loaded voltage of the one or more battery cells 212b of the second battery pack 210b. Additionally, or alternatively, the processing circuitry 110 may be configured to obtain a further second battery pack voltage 312b′ indicating an open cell voltage, i.e. an unloaded voltage, of the one or more battery cells 212b of the second battery pack 210b. The processing circuitry 110 may be configured to obtain a third battery pack voltage 312c indicating a voltage of the one or more battery cells 212c of the third battery pack 210c. Advantageously, the third battery pack voltage 312c indicates a loaded voltage of the one or more battery cells 212c of the third battery pack 210c. Additionally, or alternatively, the processing circuitry 110 may be configured to obtain a further third battery pack voltage 312c′ indicating an open cell voltage, i.e. an unloaded voltage, of the one or more battery cells 212c of the third battery pack 210c. The battery pack voltages 312a, 312a′, 312b, 312b′, 312c, 312c′ may be provided by the respective battery pack processing circuitry (not shown in FIG. 3). Additionally, or alternatively, the processing circuitry 100 may be configured to obtain the battery pack voltages 312a, 312a′, 312b, 312b′, 312c, 312c′ directly from e.g. sensor circuitry 16 of the vehicle 10 or respective sensor circuitry (not shown in FIG. 3) of the battery packs 210a, 210b, 210c.

Assuming that pre-charge is to be performed with two battery packs 210a, 210b, 210c, optionally the processing circuitry 110 may be configured to compare the obtained voltages 312a, 312a′, 312b, 312b′, 312c, 312c′ and select the two battery packs 210a, 210b, 210c having the most similar open cell voltages 312a′, 312b′, 312c′ and/or loaded cell voltages 312a, 312b, 312c. The processing circuitry 110 may be configured to cause the selected two battery packs 210a, 210b, 210c to commence pre-charge. Alternatively, the processing circuitry 110 may be configured to control the respective switches (not shown in FIG. 3) to start pre-charge. During the pre-charge, the processing circuitry 110 may monitor the battery pack voltages 312a, 312b, 312c and compare these to the load voltage 314. If one of the battery pack voltages 312a, 312b, 312c is at or below the load voltage 314, this indicate that the associated battery pack 210a, 210b, 210c is not contributing to pre-charging of the load 29. In order to decrease the pre-charge time and avoid charging the battery pack 210a, 210b, 210c with battery pack voltages 312a, 312b, 312c at or below the load voltage 314, the processing circuitry 100 may be configured to control, or cause control of the battery pack 210a, 210b, 210c with battery pack voltage 312a, 312b, 312c at or below the load voltage 314 to stop (discontinue, halt, interrupt, abstain from) pre-charging. Optionally, the processing circuit 100 may, responsive to controlling (or causing control of) one of the battery packs 210a, 210b, 210c to stop pre-charging, control (or cause control of), a further battery pack 210a, 210b, 210c to pre-charge the load 29.

By the brief example provided above, a pre-charge methodology is provided that reduces a risk of pre-charge current being spent on charging battery packs 210a, 210b, 210c rather than the load 29. However, the inventor behind the present disclosure have realized that there are even further opportunities for improvement. By distributing the control of the pre-charge to the battery packs 210a, 210b, 210c, the pre-charge may be interrupted faster and less communication is required from the battery packs 210a, 210b, 210c. Communication networks in vehicles, e.g. CAN bus, are generally slow and communication of voltages and controls across these networks will, from a pre-charge perspective, take significant time. To this end, a supportive pre-charge mode is introduced.

In FIG. 4 a schematic view of a pre-charge controller 300 according to some examples is shown. The pre-charge controller 300 and all of its functionality and features may be part of the computer system 100 and/or comprised in a vehicle 10. In an advantageous example, the pre-charge controller 300 is an, at least partly, computer implemented functionality. Advantageously, the computer implemented functionality of the pre-charge controller 300 is performed by a suitable processing circuitry 110, 211, advantageously the battery pack processing circuitry 211. In examples where the functionality of the pre-charge controller 300 is performed by the battery pack processing circuitry 211, there is a time benefit compares to having the functionality being performed remote from the battery pack 200. As mentioned, sending communication over a vehicle communication network back-and-forth typically takes longer than measuring a voltage and immediately compare it to a voltage target/limit directly at the battery pack processing circuitry 211. This is due to the measuring and logical decisions need to be performed in either case (remote or local functionality), and for the remote case, time is also needed for comparably slow two-way CAN communication.

In systems, arrangement or devices comprising more than one battery pack 210, one pre-charge controller 300 is advantageously associated with each battery pack 210. In FIG. 4, the pre-charge controller 300 is shown operatively connected to the load 29, the computer system 100 and the battery pack 210. However, this is for illustrative purposes, and the skilled person will appreciate that this should not be considered limiting for the present disclosure.

The pre-charge controller 300 comprises a switch status 302 of the switch circuitry 214, 215, 216 of the associated battery pack 210. The pre-charge controller 300 is configured to control the switch status 302 of the respective switch circuitry 214, 215, 216 during pre-charge, based on a pre-charge mode 320. The pre-charge mode 320 may be either a non-supportive pre-charge mode 322 or the supportive pre-charge mode 324. The pre-charge mode 320 is advantageously set by e.g. processing circuitry 110 of the computer system 100. Generally, if no specific pre-charge mode 320 is specified, the pre-charge controller 300 may operate in the non-supportive pre-charge mode 322.

At the non-supportive pre-charge mode 322, the pre-charge controller 300

controls the switch status 302 to provide pre-charge to the load 29. The non-supportive pre-charge 322 may be continued until an indication to stop pre-charging is obtained from e.g. processing circuitry 110 of the computer system 100. When such an indication is obtained, the pre-charge controller 300 may be configured to control the switch status 302 to disconnect the pre-charge load 213 from the load 29 and close the first switch circuitry 215.

As described with reference to FIG. 2-3, the pre-charge controller 300 may control the switch status 302 by means of controlling the first switch circuitry 215, the second switch circuitry 214 and/or the third switch circuitry 216.

At the non-supportive pre-charge mode 322, the pre-charge controller 300 may be configured to control the switch status 302 such that the second switch circuitry 214 is closed and the first switch circuitry 215 is open, causing the battery pack 200 to pre-charge the load 29. If the third switch circuitry 216 is implemented, the pre-charge controller 300 may at the non-supportive pre-charge mode 322, control the switch status 302 such that the third switch circuitry 216 is closed.

Upon receiving instructions to stop performing pre-charge of the load 29 in the non-supportive mode 322, the pre-charge controller 300 may be configured to control the switch status 302 such that the second switch circuitry 214 is open to disconnect the pre-charge load 213 and the first switch circuitry 215 is closed. If the third switch circuitry 216 is implemented, the pre-charge controller 300 may control the switch status 302 such that the third switch circuitry 216 is closed.

At the supportive pre-charge mode 324, the pre-charge controller 300 controls the switch status 302 to provide pre-charge to the load 29. Also the supportive pre-charge 324 may be continued until an indication to stop pre-charging is obtained from e.g. processing circuitry 110 of the computer system 100. When such an indication is obtained, the pre-charge controller 300 may be configured to control the switch status 302 to disconnect the pre-charge load 213 from the load 29 and to have the first switch circuitry 215 open. However, at the supportive pre-charge mode 324 the pre-charge controller 300 will also stop the pre-charge if it is determined that associated battery pack 210 does not contribute to the pre-charging of the load 29.

To this end, the pre-charge controller 300 comprises a voltage obtainer 310. The voltage obtainer 310 may be configured to obtain a battery pack voltage 312. The battery pack voltage 312 may be obtained by any suitable means, advantageously by sensor circuitry 217 of the associated battery pack 210. The voltage obtainer 310 may be configured to obtain a load voltage 314. The load pack voltage 314 may be obtained by any suitable means, advantageously by sensor circuitry 217 of the associated battery pack 210. During pre-charge, the load voltage 314 and the battery pack voltage 312 are at opposite potentials of the pre-charge load 213. This means, that (assuming the pre-charge load 213 is between a positive terminal of the one or more battery cells 212 and the load 29), if the battery pack voltage 312 is higher than the load voltage 314, current is flowing from the one or more battery cells 212 into the load 29, i.e. the battery pack 210 is contributing to pre-charging the load 29. Further (still assuming the pre-charge load 213 is between a positive terminal of the one or more battery cells 212 and the load 29), if the battery pack voltage 312 is lower than the load voltage 314, current is flowing from the load 29 into the one or more battery cells 212, i.e. the battery pack 212 is not contributing to pre-charging the load 29, but is rather forming part of the load being pre-charged. Therefore, the voltage obtainer 310 may be configured to provide a voltage difference indicator 316 that indicate if the battery pack 210 is contributing to the pre-charging the load 29 or not. Alternatively, or additionally, the voltage obtainer 310 may be configured to obtain a pre-charge current 313. In some examples, the voltage obtainer 310 may be configured to determine the voltage difference indicator 316 based on a direction (i.e.

positive or negative) of the pre-charge current 313. Further, if the current is substantially zero, this also indicate that the battery pack 210 is not contributing to pre-charging the load 29.

During pre-charge at the supportive pre-charge mode 320, the pre-charge controller 300 may be configured to abort the pre-charge if the voltage difference indicator 316 indicate that the battery pack 210 is not contributing to the pre-charge. That is to say, is the voltage difference indicator 316 indicates that the battery pack voltage 312 is at or below the load voltage 314. Optionally, if the pre-charge controller 300 aborts the pre-charge of the load 29, the pre-charge controller 300 may be configured to provide a supporting pre-charge failed indication 305, or pre-charge failed indication 305 for short, to processing circuitry 110 of the computer system 100. This beneficial as it informs the computer system 100 of the failed pre-charge and allows the computer system 100 to control further battery packs to provide pre-charge to the load 29, optionally in the supporting pre-charge mode 324.

As described with reference to FIG. 2-3, the pre-charge controller 300 may control the switch status 302 by means of controlling the first switch circuitry 215, the second switch circuitry 214 and/or the third switch circuitry 216.

At the supportive pre-charge mode 324, the pre-charge controller 300 may be configured to control the switch status 302 such that the second switch circuitry 214 is closed to connect the pre-charge load 213 to the load 29 and the first switch circuitry 215 is opened. If the third switch circuitry 216 is implemented, the pre-charge controller 300 may at the supportive pre-charge mode 321, control the switch status 302 such that the third switch circuitry 216 is closed.

Upon receiving instructions to stop performing pre-charge of the load 29 in the supportive mode 324, the pre-charge controller 300 may be configured to control the switch status 302 such that the second switch circuitry 214 is open to disconnect the pre-charge load 213 and the first switch circuitry 215 is open. If the third switch circuitry 216 is implemented, the pre-charge controller 300 may control the switch status 302 such that the third switch circuitry 216 is closed at least until the second switch circuitry 214 is opened. In one example, the pre-charge controller 300 may control the switch status 302 such that the third switch circuitry 216 is opened after the second switch circuitry 214 has opened.

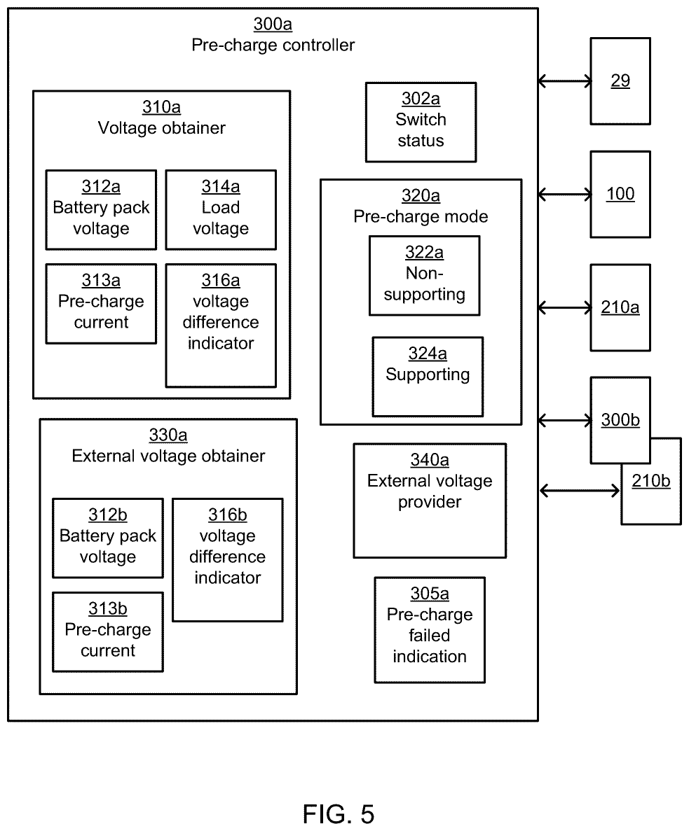

With reference to FIG. 5, another schematic view of a pre-charge controller 300a according to some examples is shown. The pre-charge controller 300a shown in FIG. 5 may be configured with all functionality and feature of the pre-charge controller 300 shown in FIG. 4. For reasons of brevity, these functions and features will not be repeated for the pre-charge controller 300a of FIG. 5. The pre-charge controller 300a shown in FIG. 5 comprises an external voltage obtainer 330a. The external voltage obtainer 330a may be configured to obtain a second battery pack voltage 312b indicating a voltage of a second, external, battery pack 210b. The second battery pack voltage 312b may be obtained by any suitable means, advantageously by a second pre-charge controller 300b associated with the second battery pack 210b. Alternatively, or additionally, the second battery pack voltage 312b may be obtained from the computer system 100 and or directly from sensors circuitry of the second battery pack 210b. Alternatively, or additionally, the external voltage obtainer 330a may be configured to obtain a pre-charge current 313b of the second battery pack 210b. The pre-charge current 313b of the second battery pack 210b may be obtained correspondingly as the second battery pack voltage 312b. Correspondingly to the voltage difference indicator 316a provided by the voltage obtainer 310a, the external voltage obtainer 330a may be configured to provide a second voltage difference indicator 316b that indicate if the second battery pack 210b is contributing to the pre-charging the load 29 or not.

During pre-charge at the supportive pre-charge mode 320, the pre-charge controller 300a may be configured to abort the pre-charge if the second voltage difference indicator 316b indicate that the second battery pack 210b is not contributing to the pre-charge. In other words, if the second pre-charge controller 300b determines that the voltage of the second battery pack 210b is at or below a load voltage sensed by the second pre-charge controller 300b, the second battery pack 210b is likely being charged by the first battery pack 210a. Assuming that the second pre-charge controller 300b is configured to provide pre-charge in the non-supporting mode, the second pre-charge controller 300b is not permitted to abort pre-charging of the load 29. However, in the present example, the first pre-charge controller 300b may respond to the voltage difference of the second pre-charge controller 300b and abort pre-charge from the first battery pack 210a such that only the second pre-charge controller 300b provides pre-charge to the load 29 (assuming no further contributers to pre-charge are available). This reduces a risk that the present battery pack 210a is charging other battery packs 210b together with the load 29.

As in FIG. 3, optionally, if the pre-charge controller 300 of FIG. 5 aborts the pre-

charge of the load 29 (for whatever reason), the pre-charge controller 300 may be configured to provide a supporting pre-charge failed indication 305 to processing circuitry 110 of the computer system 100. This beneficial as it informs the computer system 100 of the failed pre-charge and allows the computer system 100 to control further battery packs to provide pre-charge to the load 29, optionally in the supporting pre-charge mode 324.

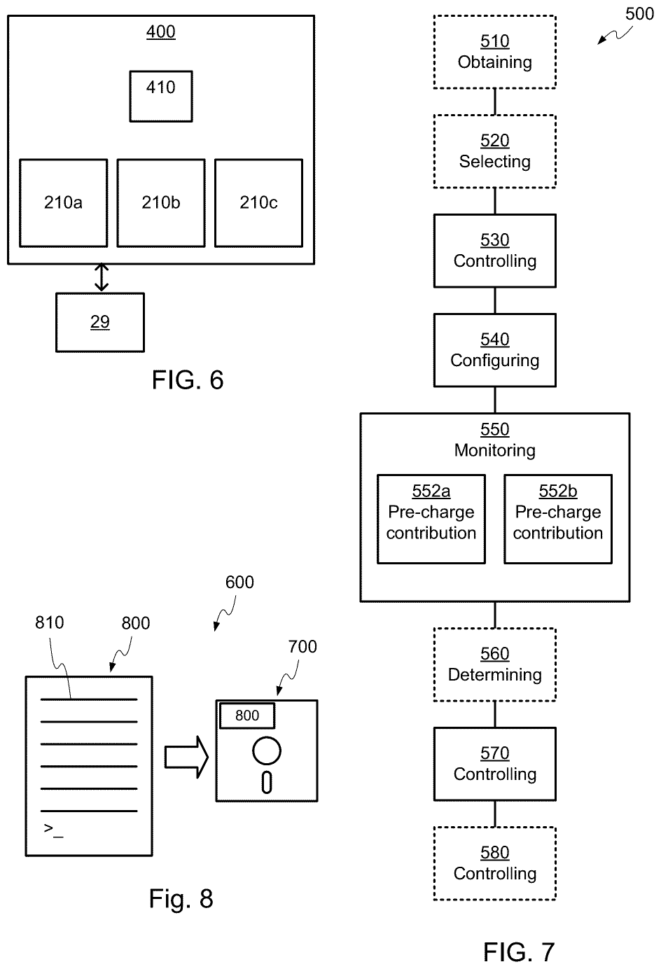

In FIG. 6 a schematic view of a battery system 400 is shown. The battery system 400 comprises at least a first battery pack 210a, a second battery pack 210b and processing circuitry 410. In FIG. 6, the battery system 400 further comprises an optional third battery pack 210c and may in other examples comprise many more than three battery packs. The processing circuitry 410 may be dedicated battery system processing circuitry or processing circuitry forming part of the processing circuitry 110 of the computer system 100. At least one of the battery packs 210a, 210b, 210c is configurable to provide pre-charge in the supporting pre-charge mode 324 as presented herein. In the following, it is assumed that at least the first battery pack 210a and the optional third battery pack 210c are configurable to provide pre-charge in the supporting pre-charge mode 324. The processing circuitry 410 is advantageously configured to control the first battery pack 210a and the second battery pack 210b to provide pre-charge to the load 29. The processing circuitry 410 is advantageously further configured to configure the first battery pack 210a to provide pre-charge in the supporting pre-charge mode 324.

In some examples, the processing circuitry 410 is further configured to monitor the second voltage difference indicator 316b as disclosed herein and provide the second voltage difference indicator 316b to the first battery pack 210a.

In some examples, responsive to obtaining a supporting pre-charge failed indication 305 from the first battery pack 210a, the processing circuitry 410 may be configured to control the third battery pack 210c to provide pre-charge to the load 29. Optionally, the processing circuitry 410 may further be conjured to configure the third battery pack 210c to provide pre-charge in the supporting pre-charge mode 324.

As mentioned above, the pre-charge is advantageously aborted if the voltage difference indicator 316 indicate that the battery pack 210 is not contributing to the pre-charge. However, for the present disclosure, this may be interpreted as the battery pack 210 is not significantly contributing to the pre-charge of the load 29. That is to say, if the voltage difference indicator 316 indicates that the battery pack voltage 312 is below a configurable threshold, the pre-charge may be aborted. The threshold may be configured with sufficient margin such that if the battery pack 210 is contributing to pre-charge of the load 29, but not contributing as much as expected, the pre-charge may be aborted.

In FIG. 7, a schematic view of a method 500 is shown. The method 500 is advantageously a computer implemented method 500. The method 500, or at least part of the method 500, is advantageously performed by processing circuitry 110 of the computer system 100. That is to say, the processing circuitry 110 may be configured to perform, in part or in full, the method 500, configured to cause, in part or in full, performance of the method 500 or a combination thereof. The method 500 will be briefly introduced with reference to FIG. 7, but the skilled person will appreciate that the method 500 may very well be extended to comprise any further feature, functionality or example presented herein.

The method 500 comprises controlling 530 a first battery pack 210a a second battery pack 210b to provide pre-charge to a load 29. The battery packs 210a, 210b arc advantageously 210a, 210b battery packs according to the present disclosure, but may be any suitable battery pack configurable to provide pre-charge to the load 29. The method 500 further comprises configuring 540 the first battery pack 210a to provide pre-charge in the supporting pre-charge mode 324. It should be mentioned that, if the first battery pack 210a is battery pack according to the present disclosure, the first battery pack 210a may indeed be configured to provide pre-charge in the supporting pre-charge mode 324B. However, if the battery pack is a general battery pack, the supporting pre-charge mode may be configured and control at a layer above the battery pack itself as described herein. The method 500 further comprises, during pre-charge in the supporting pre-charge mode 324, monitoring 552a of a pre-charge contribution of the first battery pack 210a. The monitoring 552a of the pre-charge contribution of the first battery pack 210a may be provided according to any feature, function or example presented herein. Advantageously, monitoring 552a of the pre-charge contribution of the first battery pack 210a is based a first voltage difference indicator 316a indicating a difference between a load voltage 314 and a first battery pack voltage 312a. The method 500 further comprises, responsive to determining that the first battery pack 210a is not contributing to pre-charging of the load 29 (e.g. the voltage difference indicator 316a indicating that first battery pack voltage 312a is at or below the load voltage 314), controlling 570 the first battery pack 210a to discontinue (abort, stop, seize) pre-charge of the load 29.

In some optional examples of the method 500, the method 500 further comprises determining 560 the first voltage difference indicator 316a based on the pre-charge current 313a. Additionally, or alternatively, the method 500 may comprise determining 560 the first voltage difference indicator 316a based on the first battery pack voltage 312a and the load voltage 314.

In some optional examples of the method 500, the method 500 further comprises, during pre-charge in the supporting pre-charge mode 324, monitoring 552b of a pre-charge contribution of the second battery pack 210b. The monitoring 552b of the pre-charge contribution of the second battery pack 210b may be provided according to any feature, function or example presented herein. Advantageously, the monitoring 552b of the pre-charge contribution of the second battery pack 210b may be provided by a second voltage difference indicator 316b indicating a difference between the load voltage 314 and a second battery pack voltage 312b. The method 500 further comprises, responsive to the second battery pack 210b not contributing to pre-charging of the load 29, controlling 570 the first battery pack 210a to discontinue (abort, stop, seize) pre-charge of the load 29. Advantageously, the method 500 comprises, responsive to the second voltage difference indicator 316b indicating that the second battery pack voltage 312b is below or at the load voltage 314, controlling 570 the first battery pack 210a to discontinue pre-charge of the load 29.

Optionally, on some examples, the method 500 may comprise, responsive to control of the first battery pack 210a to discontinue pre-charge of the load 29, controlling 530 a third battery pack 210c to provide pre-charge to the load 29, and configuring 540 the third battery pack 210c to provide pre-charge in the supporting pre-charge mode 324. The contribution of the third battery to the pre-charging of the load 29 may be performed as outlined in reference to the first battery pack 210a. It should be mentioned that, the method 500 (and the other examples provided herein) may very well comprising controlling the second battery pack 210b to provide pre-charge in the supporting pre-charge mode 324 responsive to aborting supportive pre-charge of the first battery pack 210a.

Optionally, in some examples, the method 500 further comprises obtaining 510 at least one of an open cell voltage 312′ or a loaded cell voltages 312 of each battery pack 210a, 210b, 210c, 210d connectable to the load 29. Advantageously, the battery packs 210a, 210b, 210c, 210d are part of a battery system 200 comprising more than two battery packs 210a, 210b, 210c, 210d. The method 500 further comprises selecting 520, the first battery pack 210a and the second battery pack 210b from the two or more battery packs 210a, 210b, 210c, 210d based the open cell voltages 312a′, 312b′, 312c′, 312d′ and/or the loaded cell voltages 312a, 312b, 312c, 312d of the battery packs 210a, 210b, 210c, 210d. Advantageously, the method 500 comprises selecting the first battery pack 210a and the second battery pack 210b by selecting a pair of battery packs 210a, 210b, 210c, 210d of the two or more battery packs 210a, 210b, 210c, 210d having the lowest difference in open cell voltages 312a′, 312b′, 312c′, 312d′ and/or loaded cell voltages 312a, 312b, 312c, 312d of each pair of battery packs 210a, 210b, 210c, 210d of the two or more battery packs 210a, 210b, 210c, 210d.

In FIG. 8 a computer program product 600 is shown. The computer program product 600 comprises a computer program 800 and a non-transitory computer readable medium 700. The computer program 800 is advantageously stored on the computer readable medium 700. The computer readable medium 700 is, in FIG. 8, exemplified as a vintage 5,25″ floppy disc, but may be embodied as any suitable non-transitory computer readable medium such as, but not limited to, hard disk drives (HDDs), solid-state drives (SSDs), optical discs (e.g., CD-ROM, DVD-ROM, CD-RW, DVD-RW), USB flash drives, magnetic tapes, memory cards, Read-Only Memories (ROM), network-attached storage (NAS), cloud storage etc.

The computer program 800 comprises instruction 810 e.g. program instruction, software code, that, when executed by processing circuitry cause the processing circuitry to perform the method 500 described herein with reference to FIG. 7.

It should be mentioned that the teachings of the present disclosure are equally applicable to other loads, and implementations in other fields than transportation and vehicles. Any system, device or arrangement wherein reduction of inrush currents and/or a controlled pre-charge is beneficial, may benefit from the present disclosure. Such system, device or arrangement may reside in the field of industrial applications or marine vessels, such as water crafts, motorboats, work boats, sport vessels, boats, ships, among other vessel types.

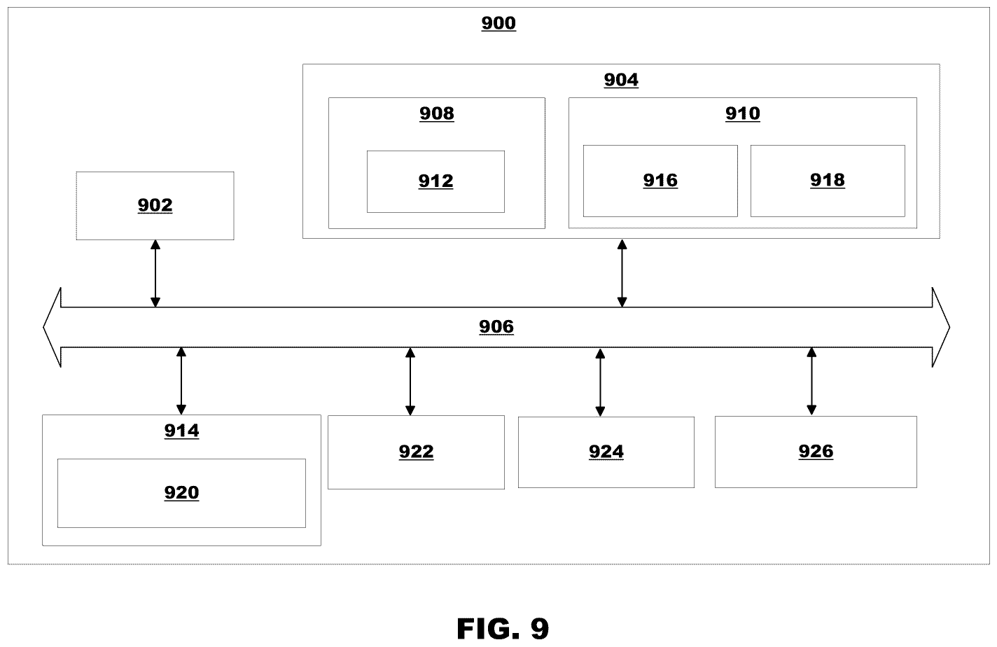

FIG. 9 is a schematic diagram of a computer system 900 for implementing examples disclosed herein. The computer system 900 shown in FIG. 9 may be the computer system 100 previously presented. The computer system 900 is adapted to execute instructions from a computer-readable medium to perform these and/or any of the functions or processing described herein. The computer system 900 may be connected (e.g., networked) to other machines in a LAN, an intranet, an extranet, or the Internet. While only a single device is illustrated, the computer system 900 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 900 may comprise at least one computing device or electronic device capable of including firmware, hardware, and/or executing software instructions to implement the functionality described herein. The computer system 900 may include processing circuitry 902 (e.g., processing circuitry including one or more processor devices or control units), a memory 904, and a system bus 906. The processing circuitry 902 may be the processing circuitry 110 of the previously presented computer system 100. The memory 904 may be the storage device 120 of the previously presented computer system 100. The computer system 900 may include at least one computing device having the processing circuitry 902. The system bus 906 provides an interface for system components including, but not limited to, the memory 904 and the processing circuitry 902. The processing circuitry 902 may include any number of hardware components for conducting data or signal processing or for executing computer code stored in memory 904. The processing circuitry 902 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 902 may further include computer executable code that controls operation of the programmable device.

The system bus 906 may be any of several types of bus structures that may further interconnect to a memory bus (with or without a memory controller), a peripheral bus, and/or a local bus using any of a variety of bus architectures. The memory 904 may be one or more devices for storing data and/or computer code for completing or facilitating methods described herein. The memory 904 may include database components, object code components, script components, or other types of information structure for supporting the various activities herein. Any distributed or local memory device may be utilized with the systems and methods of this description. The memory 904 may be communicably connected to the processing circuitry 902 (e.g., via a circuit or any other wired, wireless, or network connection) and may include computer code for executing one or more processes described herein. The memory 904 may include non-volatile memory 908 (e.g., read-only memory (ROM), erasable programmable read-only memory (EPROM), electrically erasable programmable read-only memory (EEPROM), etc.), and volatile memory 910 (e.g., random-access memory (RAM)), or any other medium which can be used to carry or store desired program code in the form of machine-executable instructions or data structures and which can be accessed by a computer or other machine with processing circuitry 902. A basic input/output system (BIOS) 912 may be stored in the non-volatile memory 908 and can include the basic routines that help to transfer information between elements within the computer system 900.

The computer system 900 may further include or be coupled to a non-transitory computer-readable storage medium such as the storage device 914, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 914 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 914 and/or in the volatile memory 910, which may include an operating system 916 and/or one or more program modules 918. All or a portion of the examples disclosed herein may be implemented as a computer program 920 stored on a transitory or non-transitory computer-usable or computer-readable storage medium (e.g., single medium or multiple media), such as the storage device 914, which includes complex programming instructions (e.g., complex computer-readable program code) to cause the processing circuitry 902 to carry out actions described herein. Thus, the computer-readable program code of the computer program 920 can comprise software instructions for implementing the functionality of the examples described herein when executed by the processing circuitry 902. In some examples, the storage device 914 may be a computer program product (e.g., readable storage medium) storing the computer program 920 thereon, where at least a portion of a computer program 920 may be loadable (e.g., into a processor) for implementing the functionality of the examples described herein when executed by the processing circuitry 902. The processing circuitry 902 may serve as a controller or control system for the computer system 900 that is to implement the functionality described herein.

The computer system 900 may include an input device interface 922 configured to receive input and selections to be communicated to the computer system 900 when executing instructions, such as from a keyboard, mouse, touch-sensitive surface, etc. Such input devices may be connected to the processing circuitry 902 through the input device interface 922 coupled to the system bus 906 but can be connected through other interfaces, such as a parallel port, an Institute of Electrical and Electronic Engineers (IEEE) 1394 serial port, a Universal Serial Bus (USB) port, an IR interface, and the like. The computer system 900 may include an output device interface 924 configured to forward output, such as to a display, a video display unit (e.g., a liquid crystal display (LCD) or a cathode ray tube (CRT)). The computer system 900 may include a communications interface 926 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1. A computer system 100 comprising processing circuitry 110 configured to: control a first battery pack 210a and a second battery pack 210b to provide pre-charge to a load 29, configure the first battery pack 210a to provide pre-charge in a supporting pre-charge mode 324, and during pre-charge in the supporting pre-charge mode 324, monitor a first voltage difference indicator 316a indicating a difference between a load voltage 314 and a first battery pack voltage 312a, and responsive to the first voltage difference indicator 316a indicating that first battery pack voltage 312a is at or below the load voltage 314, control the first battery pack 210a to discontinue pre-charge of the load 29.

Example 2. The computer system 100 of example 1, wherein the processing circuitry 110 is further configured to: monitor a pre-charge current 313a between the first battery pack 210a and the load 29, and determine the first voltage difference indicator 316a based on the pre-charge current 313a.

Example 3. The computer system 100 of example 1 or 2, wherein the processing circuitry 110 is further configured to: monitor the first battery pack voltage 312a and the load voltage 314, and determine the first voltage difference indicator 316a based on the first battery pack voltage 312a and the load voltage 314.

Example 4. The computer system 100 of any one of examples 1 to 3, wherein the processing circuitry 110 is further configured to: during pre-charge in the supporting pre-charge mode 324, monitor a second voltage difference indicator 316b indicating a difference between the load voltage 314 and a second battery pack voltage 312b, and responsive to the second voltage difference indicator 316b indicating that the second battery pack voltage 312b is at or below the load voltage 314, control the first battery pack 210a to discontinue pre-charge of the load 29.

Example 5. The computer system 100 of any one of examples 1 to 4, wherein the processing circuitry 110 is further configured to: responsive to control of the first battery pack 210a to discontinue pre-charge of the load 29, control a third battery pack 210c to provide pre-charge to the load 29, and configure the third battery pack 210c to provide pre-charge in the supporting pre-charge mode 324.

Example 6. The computer system 100 of example 5, wherein the processing circuitry 110 is further configured to: during pre-charge in the supporting pre-charge mode 324, monitor a third voltage difference indicator 316c indicating a difference between a voltage of the load 29 and a third battery pack voltage 312c, and responsive to the third voltage difference indicator 316c indicating that the third battery pack voltage 312c is at or below the voltage of the load 29, control the third battery pack 210c to discontinue pre-charge of the load 29.

Example 7. The computer system 100 of any one of examples 1 to 6, wherein the processing circuitry 110 is further configured to: obtain at least one of an open cell voltage 312′ or a loaded cell voltages 312 of each battery pack 210a, 210b, 210c, 210d of a battery system 200 comprising more than two battery packs 210a, 210b, 210c, 210d, and select the first battery pack 210a and the second battery pack 210b from the two or more battery packs 210a, 210b, 210c, 210d of the battery system 200 based the open cell voltages 210a, 210b, 210c, 210d and/or the loaded cell voltages 210a, 210b, 210c, 210d of the battery packs 210a, 210b, 210c, 210d of the battery system 200.

Example 8. The computer system 100 of example 7, wherein the processing circuitry 110 is further configured to: select the first battery pack 210a and the second battery pack 210b by selecting a pair of battery packs 210a, 210b, 210c, 210d of the two or more battery packs 210a, 210b, 210c, 210d of the battery system 200 having the lowest difference in open cell voltages 312a′, 312b′, 312c′, 312d′ and/or loaded cell voltages 312a, 312b, 312c, 312d of each pair of battery packs 210a, 210b, 210c, 210d of the two or more battery packs 210a, 210b, 210c, 210d of the battery system 200.

Example 9. The computer system 100 of example 1, wherein the processing circuitry 110 is further configured to: monitor a pre-charge current 313a between the first battery pack 210a and the load 29, and determine the first voltage difference indicator 316a based on the pre-charge current 313a; monitor the first battery pack voltage 312a and the load voltage 314, and determine the first voltage difference indicator 316a based on the first battery pack voltage 312a and the load voltage 314; during pre-charge in the supporting pre-charge mode 324, monitor a second voltage difference indicator 316b indicating a difference between the load voltage 314 and a second battery pack voltage 312b, and responsive to the second voltage difference indicator 316b indicating that the second battery pack voltage 312b is at or below the load voltage 314, control the first battery pack 210a to discontinue pre-charge of the load 29 and responsive to control of the first battery pack 210a to discontinue pre-charge of the load 29, control a third battery pack 210c to provide pre-charge to the load 29, and configure the third battery pack 210c to provide pre-charge in the supporting pre-charge mode 324; during pre-charge in the supporting pre-charge mode 324, monitor a third voltage difference indicator 316c indicating a difference between a voltage of the load 29 and a third battery pack voltage 312c, and responsive to the third voltage difference indicator 316c indicating that the third battery pack voltage 312c is at or below the voltage of the load 29, control the third battery pack 210c to discontinue pre-charge of the load 29; obtain at least one of an open cell voltage 312′ or a loaded cell voltages 312 of each battery pack 210a, 210b, 210c, 210d of a battery system 200 comprising more than two battery packs 210a, 210b, 210c, 210d, and select the first battery pack 210a and the second battery pack 210b from the two or more battery packs 210a, 210b, 210c, 210d of the battery system 200 based the open cell voltages 210a, 210b, 210c, 210d and/or the loaded cell voltages 210a, 210b, 210c, 210d of the battery packs 210a, 210b, 210c, 210d of the battery system 200; and select the first battery pack 210a and the second battery pack 210b by selecting a pair of battery packs 210a, 210b, 210c, 210d of the two or more battery packs 210a, 210b, 210c, 210d of the battery system 200 having the lowest difference in open cell voltages 312a′, 312b′, 312c′, 312d′ and/or loaded cell voltages 312a, 312b, 312c, 312d of each pair of battery packs 210a, 210b, 210c, 210d of the two or more battery packs 210a, 210b, 210c, 210d of the battery system 200.

Example 10. A computer implemented method 500 comprising: controlling 530, by processing circuitry 110 of a computer system 100, a first battery pack 210a and a second battery pack 210b to provide pre-charge to a load 29, configuring 540, by the processing circuitry 110 of the computer system 100, the first battery pack 210a to provide pre-charge in a supporting pre-charge mode 324, and during pre-charge in the supporting pre-charge mode 324, monitoring 552a, by the processing circuitry 110 of the computer system 100, a first voltage difference indicator 316a indicating a difference between a load voltage 314 and a first battery pack voltage 312a, and responsive to the first voltage difference indicator 316a indicating that first battery pack voltage 312a is at or below the load voltage 314, controlling 570, by the processing circuitry 110 of the computer system 100, the first battery pack 210a to discontinue pre-charge of the load 29.

Example 11. The computer implemented method 500 of example 10 further comprising: monitoring 552a, by the processing circuitry 110 of the computer system 100, a pre-charge current 313a between the first battery pack 210a and the load 29, and determining 560, by the processing circuitry 110 of the computer system 100, the first voltage difference indicator 316a based on the pre-charge current 313a.

Example 12. The computer implemented method 500 of example 10 or 11 further comprising: monitoring 552a, by the processing circuitry 110 of the computer system 100, the first battery pack voltage 312a and the load voltage 314, and determining 560, by the processing circuitry 110 of the computer system 100, the first voltage difference indicator 316a based on the first battery pack voltage 312a and the load voltage 314.

Example 13. The computer implemented method 500 of any one of examples 10 to 12 further comprising: during pre-charge in the supporting pre-charge mode 324, monitoring 552b, by the processing circuitry 110 of the computer system 100, a second voltage difference indicator 316b indicating a difference between the load voltage 314 and a second battery pack voltage 312b, and responsive to the second voltage difference indicator 316b indicating that the second battery pack voltage 312b is at or below the load voltage 314, controlling 570, by the processing circuitry 110 of the computer system 100, the first battery pack 210a to discontinue pre-charge of the load 29.

Example 14. The computer implemented method 500 of any one of examples 10 to 13 further comprising: responsive to control of the first battery pack 210a to discontinue pre-charge of the load 29, controlling 530, by the processing circuitry 110 of the computer system 100, a third battery pack 210c to provide pre-charge to the load 29, and configuring 540, by the processing circuitry 110 of the computer system 100, the third battery pack 210c to provide pre-charge in the supporting pre-charge mode 324.

Example 15. The computer implemented method 500 of example 14 further comprising: during pre-charge in the supporting pre-charge mode 324, monitoring, by the processing circuitry 110 of the computer system 100, a third voltage difference indicator indicating a difference between a voltage of the load 29 and a third battery pack voltage, and responsive to the third voltage difference indicator indicating that the third battery pack voltage 312c is at or below the voltage of the load 29, controlling 570, by the processing circuitry 110 of the computer system 100, the third battery pack 210c to discontinue pre-charge of the load 29.

Example 16. The computer implemented method 500 of any one of examples 10 to 15 further comprising: obtaining 510, by the processing circuitry 110 of the computer system 100, at least one of an open cell voltage 312′ or a loaded cell voltages 312 of each battery pack 210a, 210b, 210c, 210d of a battery system 200 comprising more than two battery packs 210a, 210b, 210c, 210d, and selecting 520, by the processing circuitry 110 of the computer system 100, the first battery pack 210a and the second battery pack 210b from the two or more battery packs 210a, 210b, 210c, 210d of the battery system 200 based the open cell voltages 210a, 210b, 210c, 210d and/or the loaded cell voltages 210a, 210b, 210c, 210d of the battery packs 210a, 210b, 210c, 210d of the battery system 200.

Example 17. The computer implemented method 500 of example 16 further comprising: selecting 520, by the processing circuitry 110 of the computer system 100, the first battery pack 210a and the second battery pack 210b by selecting a pair of battery packs 210a, 210b, 210c, 210d of the two or more battery packs 210a, 210b, 210c, 210d of the battery system 200 having the lowest difference in open cell voltages 312a′, 312b′, 312c′, 312d′ and/or loaded cell voltages 312a, 312b, 312c, 312d of each pair of battery packs 210a, 210b, 210c, 210d of the two or more battery packs 210a, 210b, 210c, 210d of the battery system 200.

Example 18. A vehicle 10 comprising a first battery pack 210a, a second battery pack 210b and the computer system 100 of any one of examples 1 to 9 operatively connected to the first battery pack 210a and the second battery pack 210b.

Example 19. The vehicle 10 of example 18, wherein the first battery pack 210a and the second battery pack 210b are propulsion batteries operatively connected to one or more electrical propulsion sources 12 of the vehicle 10.

Example 20. The vehicle 10 of example 18 or 19, wherein the vehicle 10 is a heavy-duty vehicle.

Example 21. A computer program product 600 comprising program code 810 for performing, when executed by a processing circuitry 110 of a computer system 100, the computer implemented method 500 of any of examples 10 to 17.

Example 22. A non-transitory computer-readable storage medium 700 comprising instructions 610, which when executed by a processing circuitry 110 of a computer system 100, cause the processing circuitry 110 to perform the computer implemented method 500 of any of examples 10 to 17.

Example 23. A battery pack 210 comprising battery pack processing circuitry 211, one or more battery cells 120 and a pre-charge load 213 selectively connected between the one or more battery cells 120 and a load 29, wherein the battery pack processing circuitry 211 is configured to: obtain instructions to perform pre-charge of the load 29 in a supporting pre-charge mode 324, connect the pre-charge load 213 between the one or more battery cells 120 and the load 29, monitor a first voltage difference indicator 316a indicating a difference between a load voltage 314 and a battery pack voltage 312, and responsive to the first voltage difference indicator 316a indicating that the battery pack voltage 312 is below or at the load voltage 314, disconnect the pre-charge load 213 from the one or more battery cells 120 and/or the load 29.

Example 24. The battery pack 210 of example 23, wherein the battery pack processing circuitry 211 is further configured to: responsive to disconnecting the pre-charge load 213 from the one or more battery cells 120 and/or the load 29, provide a supporting pre-charge failed indication 305 to processing circuitry 410 of a battery system 400.

Example 25. The battery pack 210 of example 23 or 24, wherein the battery pack processing circuitry 211 is further configured to: obtain a second voltage difference indicator 316b indicating a difference between the load voltage 314 and a second battery pack voltage 312b associated with a second battery pack 210b connected to the load 29, and responsive to the second voltage difference indicator 316b indicating that the second battery pack voltage 312b is at or below the load voltage 314, disconnect the pre-charge load 213 from the one or more battery cells 120 and/or the load 29.

Example 26. The battery pack 210 of any of example 23-25, further comprising first switch circuitry 215 arranged to connect a first pole of the one or more battery cells 212 to the load 29, second switch circuitry 214 arranged to selectively close an electric circuit between the one or more battery cells 212, the pre-charge load 213 and the load 29.

Example 27. The battery pack 210 of example 26, further comprising third switch circuitry 216 arranged to connect a second pole of the one or more battery cells 212 to the load 29.

Example 28. The battery pack 210 of example 26 or 27, wherein the battery pack processing circuitry 211 is further configured to: obtain instructions to perform pre-charge of the load 29 in a non-supportive pre-charge mode 322, open the first switch circuitry 215 and close the second switch circuitry 214, causing the battery pack 210 to pre-charge the load 29.

Example 29. The battery pack 210 of example 28, wherein the battery pack processing circuitry 211 is further configured to: control the third switch circuitry 216 to be closed.

Example 30. The battery pack 210 of any of example 26-29, wherein the battery pack processing circuitry 211 is configured to: stop performing of pre-charge of the load 29 in the non-supportive pre-charge mode 322 by controlling the second switch circuitry 214 to be open to disconnect the pre-charge load 213 and the first switch circuitry 215 to be open.

Example 31. The battery pack 210 of example 30, wherein the battery pack processing circuitry 211 is further configured to: control the third switch circuity 216 to be closed at least until the second switch circuitry 214 has been opened, preferably, the processing circuitry 211 is further configured to open the third switch circuitry 216 after the second switch circuitry 214 has opened.

Example 32. The battery pack 210 of any of examples 26-31, wherein the battery pack processing circuitry 211 is configured to: obtain instructions to perform pre-charge of the load 29 in the supporting pre-charge mode 324, close the second switch circuitry 214 to connect the pre-charge load 213 to the load 29 and open the first switch circuitry 215.

Example 33. The battery pack 210 of example 32, wherein the battery pack processing circuitry 211 is configured to: obtain instructions to perform pre-charge of the load 29 in the supporting pre-charge mode 324 and close the third switch circuitry 216.

Example 34. The battery pack 210 of any of examples 26-33, wherein the battery pack processing circuitry 211 is configured to: stop performing of pre-charge of the load 29 in the supportive pre-charge mode 324 by controlling the second switch circuitry 214 to be open to disconnect the pre-charge load 213 and the first switch circuitry 215 to be open.

Example 35. The battery pack 210 of example 34, wherein the battery pack processing circuitry 211 is further configured to: stop performing pre-charge of the load 29 in the supportive pre-charge mode 324 by controlling the third switch circuitry 216 to be open.

Example 36. A battery system 400, comprising a first battery pack 210a selectively connected to a load 29, a second battery pack 210b selectively connected to the load 29 and processing circuitry 410, at least the first battery pack 210a is a battery pack of any one of examples 23 to 35, wherein the processing circuitry 410 is configured to: control the first battery pack 210a and the second battery pack 210b to provide pre-charge to the load 29, and configure the first battery pack 210a to provide pre-charge in a supporting pre-charge mode 324.

Example 37. The battery system 400 of example 36, wherein the processing circuitry 410 is further configured to: monitor a second voltage difference indicator 316b indicating a difference between a load voltage 314 and a second battery pack voltage 312b, and provide the second voltage difference indicator 316b to the first battery pack 210a.

Example 38. The battery system 200 of example 36 or 37, further comprising a third battery pack 210c, wherein the processing circuitry 210 is further configured to: responsive to obtaining a supporting pre-charge failed 305 indication from the first battery pack 210a, control the third battery pack 210c to provide pre-charge to the load 29, and configure the third battery pack 210c to provide pre-charge in the supporting pre-charge mode 324.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first clement could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
control a first battery pack and a second battery pack to provide pre-charge to a load,
configure the first battery pack to provide pre-charge in a supporting pre-charge mode, and
during pre-charge in the supporting pre-charge mode, monitor a first voltage difference indicator indicating a difference between a load voltage and a first battery pack voltage, and
responsive to the first voltage difference indicator indicating that first battery pack voltage is at or below the load voltage, control the first battery pack to discontinue pre-charge of the load.

2. The computer system of claim 1, wherein the processing circuitry is further configured to:
monitor a pre-charge current between the first battery pack and the load, and
determine the first voltage difference indicator based on the pre-charge current.

3. The computer system of claim 1, wherein the processing circuitry is further configured to:
monitor the first battery pack voltage and the load voltage, and
determine the first voltage difference indicator based on the first battery pack voltage and the load voltage.

4. The computer system of claim 1, wherein the processing circuitry is further configured to:
during pre-charge in the supporting pre-charge mode, monitor a second voltage difference indicator indicating a difference between the load voltage and a second battery pack voltage, and
responsive to the second voltage difference indicator indicating that the second battery pack voltage is at or below the load voltage, control the first battery pack to discontinue pre-charge of the load.

5. The computer system of claim 1, wherein the processing circuitry is further configured to:
obtain at least one of an open cell voltage or a loaded cell voltages of each battery pack of a battery system comprising more than two battery packs, and
select the first battery pack and the second battery pack by selecting a pair of battery packs of the two or more battery packs of the battery system having the lowest difference in open cell voltages and/or loaded cell voltages of each pair of battery packs of the two or more battery packs of the battery system.

6. The computer system of claim 1, wherein the processing circuitry is further configured to: monitor a pre-charge current between the first battery pack and the load, and determine the first voltage difference indicator based on the pre-charge current; monitor the first battery pack voltage and the load voltage, and determine the first voltage difference indicator based on the first battery pack voltage and the load voltage; during pre-charge in the supporting pre-charge mode, monitor a second voltage difference indicator indicating a difference between the load voltage and a second battery pack voltage, and responsive to the second voltage difference indicator indicating that the second battery pack voltage is at or below the load voltage, control the first battery pack to discontinue pre-charge of the load; and obtain at least one of an open cell voltage or a loaded cell voltages of each battery pack of a battery system comprising more than two battery packs, and select the first battery pack and the second battery pack by selecting a pair of battery packs of the two or more battery packs of the battery system having the lowest difference in open cell voltages and/or loaded cell voltages of each pair of battery packs of the two or more battery packs of the battery system.

7. A computer implemented method comprising:
controlling, by processing circuitry of a computer system, a first battery pack and a second battery pack to provide pre-charge to a load,
configuring, by the processing circuitry of the computer system, the first battery pack to provide pre-charge in a supporting pre-charge mode, and
during pre-charge in the supporting pre-charge mode, monitoring, by the processing circuitry of the computer system, a first voltage difference indicator indicating a difference between a load voltage and a first battery pack voltage, and
responsive to the first voltage difference indicator indicating that first battery pack voltage is at or below the load voltage, controlling, by the processing circuitry of the computer system, the first battery pack to discontinue pre-charge of the load.

8. The computer implemented method of claim 7 further comprising:
monitoring, by the processing circuitry of the computer system, a pre-charge current between the first battery pack and the load, and
determining, by the processing circuitry of the computer system, the first voltage difference indicator based on the pre-charge current.

9. The computer implemented method of claim 7 further comprising:
monitoring, by the processing circuitry of the computer system, the first battery pack voltage and the load voltage, and
determining, by the processing circuitry of the computer system, the first voltage difference indicator based on the first battery pack voltage and the load voltage.

10. The computer implemented method of claim 7 further comprising:
during pre-charge in the supporting pre-charge mode, monitoring, by the processing circuitry of the computer system, a second voltage difference indicator indicating a difference between the load voltage and a second battery pack voltage, and
responsive to the second voltage difference indicator indicating that the second battery pack voltage is at or below the load voltage, controlling, by the processing circuitry of the computer system, the first battery pack to discontinue pre-charge of the load.

11. The computer implemented method of claim 7 further comprising:
obtaining, by the processing circuitry of the computer system, at least one of an open cell voltage or a loaded cell voltages of each battery pack of a battery system comprising more than two battery packs, and
selecting, by the processing circuitry of the computer system, the first battery pack and the second battery pack by selecting a pair of battery packs of the two or more battery packs of the battery system having the lowest difference in open cell voltages and/or loaded cell voltages of each pair of battery packs of the two or more battery packs of the battery system.

12. A vehicle comprising a first battery pack, a second battery pack and the computer system of claim 1 operatively connected to the first battery pack and the second battery pack.

13. The vehicle of claim 12, wherein the vehicle is a heavy-duty vehicle.

14. A computer program product comprising program code for performing, when executed by a processing circuitry of a computer system, the computer implemented method of claim 7.

15. A non-transitory computer-readable storage medium comprising instructions, which when executed by a processing circuitry of a computer system, cause the processing circuitry to perform the computer implemented method of claim 7.

16. A battery pack comprising battery pack processing circuitry, one or more battery cells and a pre-charge load selectively connected between the one or more battery cells and a load, wherein the battery pack processing circuitry is configured to: obtain instructions to perform pre-charge of the load in a supporting pre-charge mode, connect the pre-charge load between the one or more battery cells and the load, monitor a first voltage difference indicator indicating a difference between a load voltage and a battery pack voltage, and responsive to the first voltage difference indicator indicating that the battery pack voltage is below or at the load voltage, disconnect the pre-charge load from the one or more battery cells and/or the load.

17. The battery pack of claim 16, wherein the battery pack processing circuitry is further configured to: responsive to disconnecting the pre-charge load from the one or more battery cells and/or the load, provide a supporting pre-charge failed indication to processing circuitry of a battery system.

18. The battery pack of claim 16, wherein the battery pack processing circuitry is further configured to: obtain a second voltage difference indicator indicating a difference between the load voltage and a second battery pack voltage associated with a second battery pack connected to the load, and responsive to the second voltage difference indicator indicating that the second battery pack voltage is at or below the load voltage, disconnect the pre-charge load from the one or more battery cells and/or the load.

19. The battery pack of claim 16, further comprising first switch circuitry arranged to connect a first pole of the one or more battery cells to the load, second switch circuitry arranged to selectively close an electric circuit between the one or more battery cells, the pre-charge load and the load.

20. The battery pack of claim 19, further comprising third switch circuitry arranged to connect a second pole of the one or more battery cells to the load.
